(19) United States
(12) Patent Application Publication
(10) Pub. No.: US 2023/0247335 A1
(43) Pub. Date: Aug. 3, 2023

(54) OPTICAL COMMUNICATION MONITORING DEVICE

(71) Applicant: NIPPON TELEGRAPH AND TELEPHONE CORPORATION, Tokyo (JP)

(72) Inventors: Sei KOU, Musashino-shi, Tokyo (JP); Tomoya HATANO, Musashino-shi, Tokyo (JP); Hirotaka UJIKAWA, Musashino-shi, Tokyo (JP); Yuka OKAMOTO, Musashino-shi, Tokyo (JP)

(73) Assignee: NIPPON TELEGRAPH AND TELEPHONE CORPORATION, Tokyo (JP)

(21) Appl. No.: 18/024,953

(22) PCT Filed: Sep. 11, 2020
(86) PCT No.: PCT/JP2020/034480

§ 371 Date: Mar. 6, 2023

(51) Int. Cl. H04Q 11/00

(52) U.S. Cl. CPC H04Q 11/0067; H04L 45/28

(57) ABSTRACT

A plurality of optical sensors (3) are each installed in an optical path control device (1) that controls a corresponding one of the plurality of optical paths (2) without using an electrical element. Each of the plurality of optical sensors (3) detects an optical signal passing through the corresponding one of the plurality of optical paths (2). A transmitter (4) determines a communication state of the corresponding one of the plurality of optical paths (2) based on detection of the optical signal by the corresponding one of the plurality of optical sensors (3), and transmits information on the determined communication state. A power supplying optical signal generation unit (11) generates a power supplying optical signal. An optical signal synthesizing device (12) synthesizes the power supplying optical signal with the optical signal and transmits a signal obtained by the synthesis to the optical path control device (1). A storage battery (13) supplies electric power to the transmitter (1). A photoelectric conversion unit (14) converts the power supplying optical signal branched from the optical signal in the optical path control device (1) into an electrical output and supplies the electrical output to the storage battery (13).

### TECHNICAL FIELD

The present disclosure relates to an optical communication monitoring device that monitors a communication state of an optical path control device having no electrical element.

### BACKGROUND ART

In an optical communication system such as a passive optical network (PON) system, a device has been proposed that specifies a failure section in case where a communication failure occurs in an optical path (see, for example, Patent Literature 1).

### CITATION LIST

### Patent Literature

Patent Literature 1: JP 2010-171652 A

### SUMMARY OF INVENTION

### Technical Problem

The optical communication system uses an optical path control device such as an optical splitter that branches an optical path, a coupler that concentrates optical paths, or a patch panel that switches optical paths. The optical path control device controls an optical path without using an electrical element, and thus cannot monitor a communication state of the optical path. Therefore, it is difficult to specify a failed optical path in a case where a communication failure occurs, and it takes time to specify the failed optical path. This difficulty is a larger problem in a case where there are many failures or in a case where the failures are scattered in various places.

In addition, in a case where a device for monitoring a communication state of an optical path is provided, external power supply such as a battery is required for the device, and thus there is also a problem that a burden of maintenance and operation, such as battery replacement, increases.

The present disclosure has been made to solve the above-described problems, and an object thereof is to obtain an optical communication monitoring device capable of monitoring a communication state of an optical path control device having no electrical element and reducing a burden of maintenance and operation.

### Solution to Problem

An optical communication monitoring device according to the present disclosure includes: an optical sensor that is installed in an optical path control device configured to control an optical path without using an electrical element and detects an optical signal passing through the optical path; a transmitter that determines a communication state of the optical path based on detection of the optical signal by the optical sensor and transmits information on the determined communication state; a power supplying optical signal generation unit that generates a power supplying optical signal; an optical signal synthesizing device that synthesizes the power supplying optical signal with the optical signal and transmits a signal obtained by the synthesis to the optical path control device; a storage battery that supplies electric power to the transmitter; and a photoelectric conversion unit that converts the power supplying optical signal branched from the optical signal in the optical path control device into an electrical output and supplies the electrical output to the storage battery.

### Advantageous Effects of Invention

According to the present disclosure, it is possible to monitor a communication state of an optical path control device having no electrical element. In addition, it is possible to reduce a burden of maintenance and operation because external power supply is unnecessary.

### BRIEF DESCRIPTION OF DRAWINGS

FIG. 1 is a diagram illustrating an optical communication system according to a first embodiment.

FIG. 2 is a diagram illustrating an optical communication monitoring device according to the first embodiment.

FIG. 3 is a diagram illustrating the optical communication monitoring device according to the first embodiment.

FIG. 4 is a diagram illustrating an optical communication monitoring device according to a second embodiment.

### DESCRIPTION OF EMBODIMENTS

An optical communication monitoring device according to each embodiment will be described with reference to the drawings. The same or corresponding components are denoted by the same reference signs, and repetition of the description may be omitted.

### First Embodiment

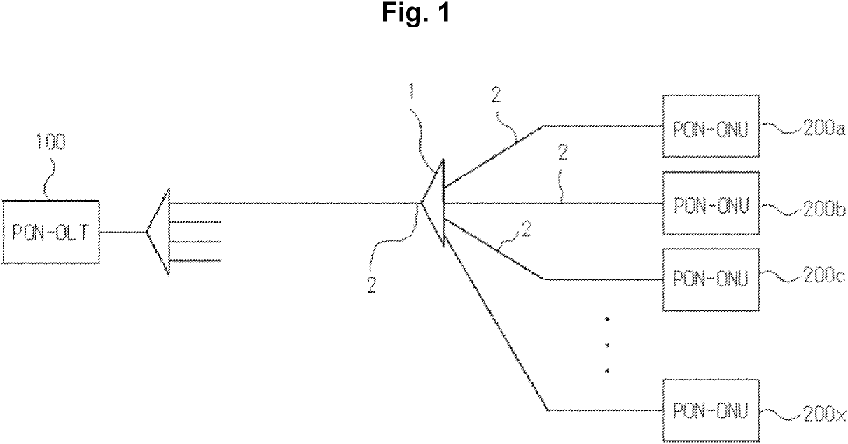

FIG. 1 is a diagram illustrating an optical communication system according to a first embodiment. This optical communication system is a passive optical network (PON) system. A master station device 100 is connected to a plurality of slave station devices 200a to 200× via optical paths, and performs optical communication with each of the plurality of slave station devices 200a to 200×. The master station device 100 is an optical line termination or optical line terminal (OLT). The slave station devices 200a to 200× are optical network units (ONUs). In the PON system, an optical path control device 1 is a coupler that concentrates a plurality of optical paths 2 each connected to a corresponding one of the plurality of slave station devices 200a to 200× on an optical path 2 connected to the master station device 100. Each of the optical paths 2 is an optical fiber (optical core wire) or the like.

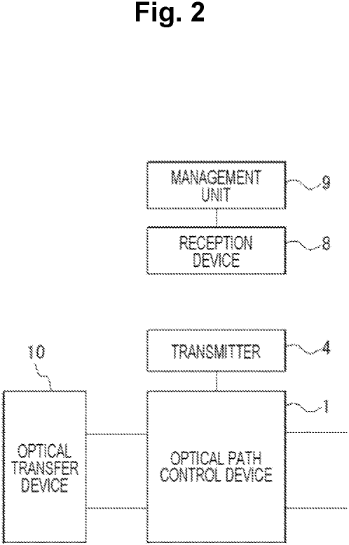

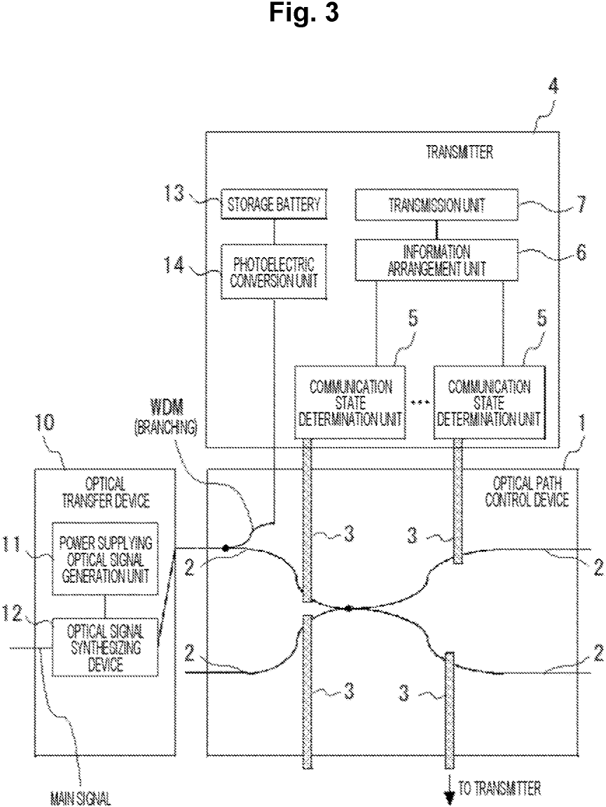

FIGS. 2 and 3 are diagrams illustrating an optical communication monitoring device according to the first embodiment. The optical path control device 1 controls the optical paths 2 without using an electrical element, and is an optical passive component such as an optical splitter that branches an optical path, a coupler that concentrates a plurality of optical paths, or a patch panel that switches light of a plurality of optical paths. For example, the optical path control device 1 is a device that distributes N optical paths to M optical paths (N and M are integers of 1 or more). The optical passive component includes no electrical element and functions without requiring electric power supply.

A plurality of optical sensors 3 are each installed in a corresponding one of the plurality of optical paths 2 of the optical path control device 1. Each of the plurality of optical sensors 3 detects an optical signal passing through the corresponding one of the plurality of optical paths 2. Here, each of the optical sensors 3 is a light receiving element such as a photodiode that converts leakage light of the optical signal passing through the corresponding one of the optical paths 2 into an electrical signal and provides the electrical signal to a transmitter 4 outside the optical path control device 1. The electrical signal does not have to be provided constantly, and may be provided once every certain period in accordance with the transmission frequency of the optical signal. Detection of the optical signal is, for example, detection of the presence or absence or intensity of the optical signal.

The transmitter 4 is a device related to Internet of things (IoT), and includes a plurality of communication state determination units 5, an information arrangement unit 6, and a transmission unit 7. Each of the plurality of communication state determination units 5 is provided for a corresponding one of the plurality of optical sensors 3, and determines a communication state of a corresponding one of the plurality of optical paths 2 based on detection of an optical signal by the corresponding one of the plurality of optical sensors 3. The information arrangement unit 6 collectively converts the determination results of the plurality of communication state determination units 5 into information with which the communication state (port state) of each optical path can be grasped. The transmission unit 7 transmits the information to the outside of the transmitter 4.

A reception device 8 is a device related to IoT, and receives the information transmitted from the transmitter 4 through a communication network such as the Internet. A management unit 9 is a general term for functional units that manage a network. The management unit 9 specifies a failed one of the optical paths 2 based on the information received by the reception device 8. With this configuration, it is possible to monitor a communication state of the optical path control device 1 having no electrical element.

An optical transfer device 10 is a device that transfers an optical signal (main signal) to the optical path control device 1, and includes a power supplying optical signal generation unit 11 and an optical signal synthesizing device 12. The power supplying optical signal generation unit 11 generates a power supplying optical signal. The power supplying optical signal has a dedicated wavelength different from that of the main signal. The optical signal synthesizing device 12 synthesizes the power supplying optical signal with the optical signal (main signal) and transmits a signal obtained by the synthesis to the optical path control device 1. Note that, in a case where the power supplying optical signal generation unit 11 does not emit light, the optical signal synthesizing device 12 transmits only the main signal.

A storage battery 13 has constant electric power in advance and supplies electric power to each unit of the transmitter 4. In a case where each of the optical sensors 3 is a light receiving element, the storage battery 13 also supplies electric power to the optical sensors 3. The optical path control device 1 branches the power supplying optical signal by wavelength division multiplexing (WDM) before a diverging point of a downlink optical path. Each of the optical sensors 3 detects only the main signal after the power supplying optical signal is branched.

A photoelectric conversion unit 14 converts the power supplying optical signal branched from the optical signal in the optical path control device 1 into an electrical output and supplies the electrical output to the storage battery 13. The storage battery 13 stores the electricity supplied from the photoelectric conversion unit 14 as electric power. This configuration eliminates need for external power supply to the transmitter 4, thereby reducing a burden of maintenance and operation.

Note that the power supplying optical signal generation unit 11 does not need to emit light all day, and may emit light in a certain time zone based on the specification of the transmitter 4. In addition, although the optical path control device 1 branches the power supplying optical signal from one optical path and provides the power supplying optical signal to the photoelectric conversion unit 14 in the drawing, the power supplying optical signal may be branched from a plurality of optical paths and provided.

### Second Embodiment

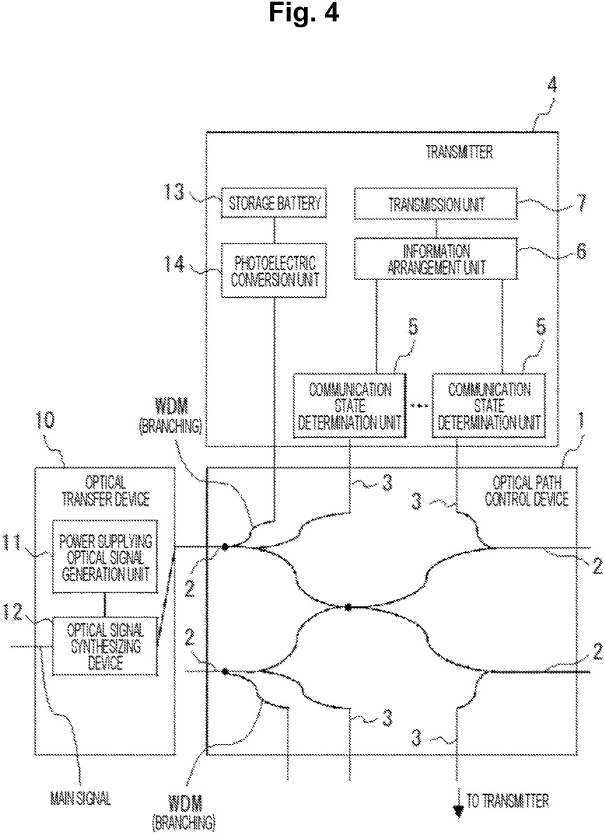

FIG. 4 is a diagram illustrating an optical communication monitoring device according to a second embodiment. Unlike the first embodiment, each of the optical sensors 3 is an optical splitter that branches a part of an optical signal passing through a corresponding one of the optical paths 2 and provides the part of the optical signal to the transmitter 4. The plurality of communication state determination units 5 determine communication states of the plurality of optical paths 2 based on optical signals each branched from a corresponding one of the plurality of optical sensors 3. The configuration of the second embodiment is similar to that of the first embodiment other than this point. With this configuration, effects similar to those of the first embodiment can be obtained. Note that, in order to suppress a reduction in light intensity of a main signal, it is preferable that the branching ratio is not 1 : 1 but the ratio of an optical signal toward the transmitter 4 is reduced.

Here, if each of the optical sensors 3 also detects an optical signal exiting from the inside of the optical path control device 1, it is difficult to know which of the optical paths 2 a signal has passed through. Therefore, each of the optical sensors 3 needs to detect an optical signal entering the optical path control device 1 from the outside. Therefore, in a case where the optical path control device 1 is a coupler or a splitter, it is preferable to use an optical splitter of the present embodiment as each of the optical sensors 3 rather than a light receiving element of the first embodiment. In a case where the optical path control device 1 is a device having no branch, such as a patch panel, a light receiving element may be used as each of the optical sensors 3.

Note that, in the first and second embodiments, the optical path control device 1 has been described by taking a coupler as an example, but the branching ratio of the coupler is not limited. In addition, even in a case where the optical path control device 1 is not a coupler but an optical switch, the optical communication monitoring device has a configuration similar to that described above. Furthermore, the transmitter 4 is detachable from the optical path control device 1. Even if the transmitter 4 fails or the electric power supply to the transmitter 4 is stopped, a main signal of an optical signal is not affected.

### REFERENCE SIGNS LIST

1 Optical path control device
2 Optical path
3 Optical sensor
4 Transmitter
5 Communication state determination unit
6 Information arrangement unit
7 Transmission unit
8 Reception device
9 Management unit
11 power supplying optical signal generation unit
12 Optical signal synthesizing device
13 Storage battery
14 Photoelectric conversion unit
100 Master station device
200a to 200x Slave station device

1. An optical communication monitoring device comprising:
an optical sensor that is installed in an optical path control device configured to control an optical path without using an electrical element and detects an optical signal passing through the optical path;
a transmitter that determines a communication state of the optical path based on detection of the optical signal by the optical sensor and transmits information on the determined communication state;
a power supplying optical signal generation unit that generates a power supplying optical signal;
an optical signal synthesizing device that synthesizes the power supplying optical signal with the optical signal and transmits a signal obtained by the synthesis to the optical path control device;
a storage battery that supplies electric power to the transmitter; and
a photoelectric conversion unit that converts the power supplying optical signal branched from the optical signal in the optical path control device into an electrical output and supplies the electrical output to the storage battery.

2. The optical communication monitoring device according to claim 1, wherein the optical signal and the power supplying optical signal have different wavelengths.

3. The optical communication monitoring device according to claim 1, wherein
the optical path includes a plurality of optical paths,
the optical path control device branches, concentrates, or switches the plurality of optical paths, and
the optical sensor includes a plurality of optical sensors that detect optical signals each passing through at least one of the plurality of optical paths.

4. The optical communication monitoring device according to claim 3, wherein
the transmitter includes:
a plurality of communication state determination units each of which determines a communication state of a corresponding one of the plurality of optical paths based on detection of a corresponding one of the optical signals by a corresponding one of the plurality of optical sensors;
an information arrangement unit that collectively converts determination results of the plurality of communication state determination units into the information; and
a transmission unit that transmits the information.

5. The optical communication monitoring device according to claim 3, further comprising:
a reception device that receives the information transmitted from the transmitter; and
a management unit that specifies a failed one of the optical paths based on the information received by the reception device.

6. The optical communication monitoring device according to claim 1, wherein the optical sensor is a light receiving element that converts the optical signal passing through the optical path into an electrical signal and provides the electrical signal to the transmitter.

7. The optical communication monitoring device according to claim 1, wherein the optical sensor is an optical splitter branches a part of the optical signal passing through the optical path and provides the part of the optical signal to the transmitter.
